(19) United States
(12) Patent Application Publication
(10) Pub. No.: US 2024/0411386 A1
(43) Pub. Date: Dec. 12, 2024

(54) SYSTEM AND METHOD FOR OPERATIONAL MANAGEMENT OF WIRELESS DEVICE

(71) Applicant: Universal City Studios LLC, Universal City, CA (US)

(72) Inventors: Wei Cheng Yeh, Orlando, FL (US); Rachel Elise Rodgers, Orlando, FL (US); Christina Corrine Lee, Richmond, VA (US)

(21) Appl. No.: 18/678,535

(22) Filed: May 30, 2024

Related U.S. Application Data
(60) Provisional application No. 63/472,147, filed on Jun. 9, 2023.

(51) Int. Cl. G06F 3/0346; G06F 3/01; H02J 7/00

(52) U.S. Cl. CPC G06F 3/0346; G06F 3/016; H02J 7/0044

(57) ABSTRACT

A portable device aim identification system includes a display screen, a transceiver, a portable device, and an interactive device system. The portable device includes multiple antennas. The transceiver, which is separate from the portable device, is configured coordinate with the multiple antennas of the portable device to generate data based on signals communicated between the transceiver and the multiple antennas. The interactive device system functions to track position and/or orientation of the portable device based on the data, identify an aim location of the portable device based on the position and/or orientation of the portable device, and control the display screen to present a graphic at the aim location in response to the aim location being on the display screen.

### CROSS-REFERENCE TO RELATED APPLICATION

This application claims priority to and the benefit of U.S. Provisional Application No. 63/472,147, entitled “SYSTEMS AND METHODS FOR OPERATIONAL MANAGEMENT OF WIRELESS DEVICE” and filed Jun. 9, 2023, which is incorporated by reference herein in its entirety for all purposes.

### BACKGROUND

This section is intended to introduce the reader to various aspects of art that may be related to various aspects of the present disclosure. This discussion is believed to be helpful in providing the reader with background information to facilitate a better understanding of the various aspects of the present disclosure. Accordingly, it should be noted that these statements are to be read in this light and not as admissions of prior art.

Amusement parks may include various entertainment attractions. Some entertainment attractions may provide an interactive environment for guests and may be referred to as interactive attractions. In an example interactive attraction, guests may employ user operable devices to interact with aspects of the environment to trigger responses. As a specific example, a toy incorporating a battery-powered laser pointer may be employed to tag targets, which may operate to initiate a special effect in response to detecting light from the laser pointer. In this example, it may be necessary to maintain the various targets (e.g., light detectors), replace batteries for the laser pointer, and perform other operations that reduce operational efficiency. It is now recognized that it is desirable to develop systems and methods for efficiently providing interactive attractions.

### BRIEF DESCRIPTION OF THE DRAWINGS

These and other features, aspects, and advantages of the present disclosure will become better understood when the following detailed description is read with reference to the accompanying drawings in which like characters represent like parts throughout the drawings, wherein:

FIG. 1 illustrates an interactive system that facilitates interactions within an interactive environment, in accordance with an embodiment of the present disclosure;

FIG. 2 depicts a perspective view of the portable device being inserted into a charging station, in accordance with an embodiment of the present disclosure;

FIG. 3 is a schematic bottom view of a nose cone of the portable device and a cradle of the charging station, wherein a portable device electrical coupler is being coupled to a charging system electrical coupler, in accordance with an embodiment of the present disclosure; and

FIG. 4 is a schematic diagram of the charging system and various protective layers within the charging system, in accordance with an embodiment of the present disclosure.

### DETAILED DESCRIPTION

One or more specific embodiments will be described below. In an effort to provide a concise description of these embodiments, not all features of an actual implementation are described in the specification. It should be appreciated that in the development of any such actual implementation, as in any engineering or design project, numerous implementation-specific decisions must be made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

When introducing elements of various embodiments of the present disclosure, the articles “a,” “an,” “the,” and “said” are intended to mean that there are one or more of the elements. The terms “comprising,” “including,” and “having” are intended to be inclusive and mean that there may be additional elements other than the listed elements. One or more specific embodiments of the present embodiments described herein will be described below. In an effort to provide a concise description of these embodiments, all features of an actual implementation may not be described in the specification. It should be noted that in the development of any such actual implementation, as in any engineering or design project, numerous implementation-specific decisions must be made to achieve the developers' specific goals, such as compliance with system-related and business-related constraints, which may vary from one implementation to another. Moreover, it should be noted that such a development effort might be complex and time consuming, but would nevertheless be a routine undertaking of design, fabrication, and manufacture for those of ordinary skill having the benefit of this disclosure.

The present disclosure relates generally to an interactive environment that utilizes portable devices to provide interactive experiences to guests (e.g., users). In an embodiment, the interactive environment is implemented within an amusement park attraction, such as in a ride attraction in which the guests are carried in ride vehicles through the interactive environment and/or a walk-through attraction in which the guests walk through the interactive environment. In an embodiment, the amusement park attraction may be a hybrid attraction in which the guests are both carried (e.g., on a moving walkway) and are permitted to walk (e.g., along the moving walkway) through the interactive environment. The interactive environment may be distributed across multiple different zones within an attraction or even distributed across multiple different amusement park attractions (e.g., geographically separated from one another), such as across multiple different ride attractions, walk-through attractions, and/or hybrid attractions. Additionally or alternatively, the interactive environment may be included within one or more themed areas and/or distributed across multiple different themed areas having a common theme or different themes. Additionally or alternatively, the interactive environment may include a live show (e.g., with performers), and the guests in an audience may participate in the live show using their portable devices.

The portable devices may be any of a variety of types of devices that are configured to be carried, held, and/or worn by the guests. For example, the portable devices may include targeting devices (e.g., blasters), wands, toys, figurines, clothing, jewelry, bracelets, headgear, medallions, glasses, and/or any combination thereof (e.g., targeting devices integrated into bracelets). In an embodiment, the portable devices may be configured to be used by multiple different guests over time. For example, a guest may pick up a portable device at an entrance to the interactive environment, use the portable device to participate in the interactive environment as the guest travels through the interactive environment, and then return the portable device as the guest exits the interactive environment. The portable device may include a rechargeable battery system (e.g., a single battery or multiple batteries that work together or separately) that provides power to features (e.g., lighting, haptic feedback devices, audio speakers) of the portable device. When charged or otherwise ready for reuse (e.g., after cleaning), the portable device may be made available again at the entrance to the interactive environment, and then another guest may pick up the portable device at the entrance to the interactive environment and use the portable device to participate in the interactive environment, and so on.

As discussed herein, the portable devices may enable the guests to interact with (e.g., to control) features within the interactive environment. For example, a portable device may be a targeting device, and the guest may actuate an input mechanism (e.g., trigger switch, push-button) of the portable device to initiate a simulation of a delivery (e.g., virtual delivery) of a virtual projectile toward an interactive element (e.g., a physical interactive element in a physical, real-world space or a virtual interactive element in a virtual space on a display screen) within the interactive environment. In response, the interactive environment may portray the virtual projectile landing on (e.g., “striking”; “hitting”) the interactive element. For example, the display screen may display an image (e.g., moving image; video) that portrays the virtual projectile landing on (e.g., “striking”; “hitting”) the interactive element. In another example, a change in the behavior of a physical interactive element or presence of special effects (e.g., sound, light, smoke, vibrations) in the interactive environment may indicate a successful targeting of the physical interactive element.

Generally, there may be two types of interactive elements: an interactive physical element, which is a prop or a physical object in the physical, real-world space within the interactive environment, and an interactive virtual element, which is an image/animation of a virtual object displayed in the virtual space on the display screen. Both interactive physical elements and interactive virtual elements may be dynamic interactive elements that move around and/or contain moving parts in the interactive environment/on the display screen. In addition, an interactive hybrid element may be an interactive physical element and an interactive virtual element simultaneously by having physical portions in the physical, real-world space within the interactive environment and virtual portions displayed in the virtual space on the display screen. Herein, “interactive element” generally refers to any interactive physical element, interactive virtual element, or interactive hybrid element.

With respect to the interactive physical elements, the interactive virtual elements, and non-interactive elements (e.g., a mere prop), it is presently recognized that it may be useful to facilitate a user of a portable device (e.g., a targeting device) to readily identify where the targeting device is aimed. For example, if the attraction includes an interactive game in which points are scored for successfully targeting (e.g., pointing at a physical or virtual element and activating a trigger while aligned therewith), it would be useful to be able to see a reticle or visual indicator of where the portable device is aimed. In traditional systems, this may be achieved with some form of light emitter (e.g., a laser pointer) that is integrated with the portable device and projects light onto any of various different surfaces (e.g., a screen displaying a virtual element or a surface of a physical element), thus indicating where the portable device is aimed. However, it is now recognized that targeting techniques such as this traditionally require incorporation of components (e.g., a laser pointer) into the portable device and use of extra power by the portable device. It is further recognized that, in the interest of efficiency, it would be desirable to avoid such onboard features to limit associated costs and inefficiencies.

Accordingly, the present disclosure relates to an interactive device system that provides positional and/or orientation tracking of a portable device being utilized within an interactive environment based on signals transmitted from an external transceiver (e.g., via an antenna) to multiple antennas disposed on the portable device. In general, the antennas of the portable device are disposed in different locations (e.g., on one or more surface, such as one or more interior surfaces, one or more exterior surfaces, or both) of the portable device. As such, signals transmitted by the external transceiver may be received by each antenna during a time that is related to a distance between each antenna and the external transceiver. A processor system (e.g., on a separate device and/or on the portable device) receives signals via multiple antennas associated with one or more transceivers and determines a time of flight indicating the time the antennas received the signals. For example, the time of flight information may indicate a first timestamp corresponding to transmission of the signals by the transceiver via its antennas and a second timestamp corresponding to receipt of the signals by a transceiver or receiver via its antennas (e.g., a timestamp corresponding to receipt of signals by each interactive device, a difference in the timestamp corresponding to receipt of the signal, and the like). Based on the determined time of flight, the processor may communicate (e.g., via ultra-wideband (UWB) communication) signals that include position information (e.g., three-dimensional Cartesian coordinates, polar coordinates, and the like), orientation information (e.g., a direction a particular location of the interactive device is facing, a degree of roll, pitch, and/or yaw of the interactive device), or both, to an external controller (e.g., an environment controller), which may cause the environment controller to adjust one or more features of the interactive environment. By detecting antennas onboard the portable device, tracking orientation information and/or position information of the portable device may be obtained without the use of expensive sensors and/or sensors utilizing a relatively large amount of power, such as an inertial measurement unit (IMU). Further, because the position and/or orientation of the portable device can be determined, where it is pointing can be determined and a reticle or other visual indicator can be depicted to show where it is pointing without the use of an onboard light emitter (e.g., a laser pointer) operable to provide such a visual indicator (e.g., reticle).

In some embodiments, the portable device may be a wearable device, a handheld device, or any of a variety of devices that are otherwise configured to be carried (e.g., held or worn) by the user. For example, the portable device may be a wand, a helmet, a bracelet, a headband, a head-mounted display (e.g., including or configured to couple to the headband or other structure that supports the head-mounted display on a head of the user; configured to display images for visualization by the user wearing the head-mounted display to create augmented reality [AR], virtual reality [VR], or mixed reality [both AR and VR] experiences for the user wearing the head-mounted display), or other device. Additionally or alternatively, in some embodiments, the portable device may be an interactive tool, such as a projectile (e.g., virtual and/or physical projectile) launcher, including a slingshot, a bow, a catapult, a blaster, water hose, or other device that is capable of emitting, shooting, or launching virtual and/or physical projectiles (e.g., wherein the virtual and/or physical projectiles may comprise virtual and/or physical kinetic outputs, energy, fluids, and/or lights), used in an interactive environment. In any case, the orientation information and/or position information may be used to determine whether the projectiles, virtual or physical, as well as the projectile launcher, are aiming or otherwise interacting with the one or more features of the interactive environment.

The interactive device system discussed above provides positional and/or orientation tracking of the portable device based on signals transmitted from an external transceiver (e.g., via an antenna) to multiple antennas disposed on the portable device. By tracking the portable device in this manner, certain power-consuming features that would traditionally be housed onboard the portable device can be eliminated. However, the portable device may still include numerous power-consuming features (e.g., a haptic feedback device, lighting, one or more speakers). Accordingly, present embodiments also include a rechargeable battery and a charging system. The charging system includes a charging station that incorporates or communicatively couples with a power source and communicatively couples with the portable device to provide the portable device with a charge. The charging station may include an electrical coupler that readily couples with the portable device without requiring tools or fasteners. For example, the electrical coupler may be a pad, cradle, receptacle, or other engagement features that engages with the portable device in a manner that allows transmission of electricity from the power source to a battery system (e.g., one or more batteries) onboard the portable device.

The charging station may interface with and charge the portable device through connection via electrically conducting (e.g., metal) components (e.g., charging pins). However, direct metal to metal conduction of electricity can create issues with longevity of circuit boards and related electronics. Accordingly, to protect the portable device from abnormal voltage and/or current transmissions (e.g., transient voltage and/or current), present embodiments may incorporate various layers of electrical protection. For example, these layers may prevent damage to the portable device or at least prevent damage to certain critical and/or expensive components thereof by protecting against oscillatory/aperiodic current and/or unwanted voltage swings (e.g., due to electromagnetic disturbances).

First and second layers of this electrical protection may be external to the portable device (e.g., integrated with or coupled with the charging station). In particular, the first layer may include a surge stopper of the charging system that prevents an over-current or over-voltage event from entering the portable device. A second layer includes a circuit breaker (e.g., a 24V/2 Amp circuit breaker). Even if voltage or current from the charging system is only transient for 20 milliseconds, the surge stopper and/or circuit breaker may operate to prevent the voltage or current from reaching the portable device.

A third layer of electrical protection may include a hot swap circuit incorporated into the portable device at a location operable to engage with the charging station to facilitate transfer of electricity from the charging station to a battery system of the portable device. The hot swap circuit may employ one or more linear diodes to prevent transient voltage/current from entering the portable device. The hot swap circuit (e.g., a hot swap integrated circuit) may be positioned on a nose (e.g., a nose cone) of the portable device (e.g., a blaster) and may include onboard conductive portions (e.g., conductive pins) that contact conductive portions (e.g., conductive pins) of the charging system in an engaged configuration. For example, the hot swap circuit may engage and conduct electricity when the portable device (e.g., a blaster) is holstered in a charging receptacle of the charging system. The hot swap circuit, which may include an electronic circuit breaker (ECB) and a transient voltage suppressor (TVS), may operate to validate that the portable device is actually getting no more than it can take without damaging certain components (e.g., no more than 28V/2 Amp). If the hot swap circuit receives current or voltage above a threshold (e.g., a level designated for protecting other components of the portable device), the hot swap circuit may fail (e.g., sacrifice itself or blow a diode) to prevent damage to other aspects (e.g., a battery management system) of the portable device. When such a failure occurs, the event may be detected and indicated by the charging system.

Conductive portions (e.g., conductive pins) of the portable device, as referenced above, may be integrated with or coupled to the hot swap circuit. The conductive portions may be positioned on a body of the portable device (e.g., on a nose or barrel of a blaster) to facilitate engagement with the charging system. As a fourth layer of protection, the conductive portions are offset conductors. That is, a first conductor may be offset from a second conductor along a path of engagement with the charging station such that primary engagement with a ground is assured when coupling the portable device with the charging system. As a specific example, the portable device may slide into a receptacle of the charging station to enter a charging configuration and the ground conductor may be arranged to engage with a corresponding conductor of the charging station before the conductor for providing positive power is engaged. Further, one or more diodes may be positioned to prevent reverse polarity. Indeed, even if an error in assembly results in reversed wiring in the charging system, the one or more diodes will prevent undesired electrical transmission and related damage. For example, even if positive power is applied to the ground pin by mistake, the diode will prevent it from passing through.

A fifth layer of protection may include a battery charging circuit that communicates with a battery management system. The battery charging circuit directs electricity to a battery system (e.g., a single or multiple batteries) onboard the portable device for charging. The battery charging circuit can communicate information regarding a status or state of the battery system. Thus, the battery management system and the battery charging circuit may cooperate to communicate regarding power needs and control transfer of power through the portable device. Such control may include operating to avoid damage to certain components by preventing overcharging and the like.

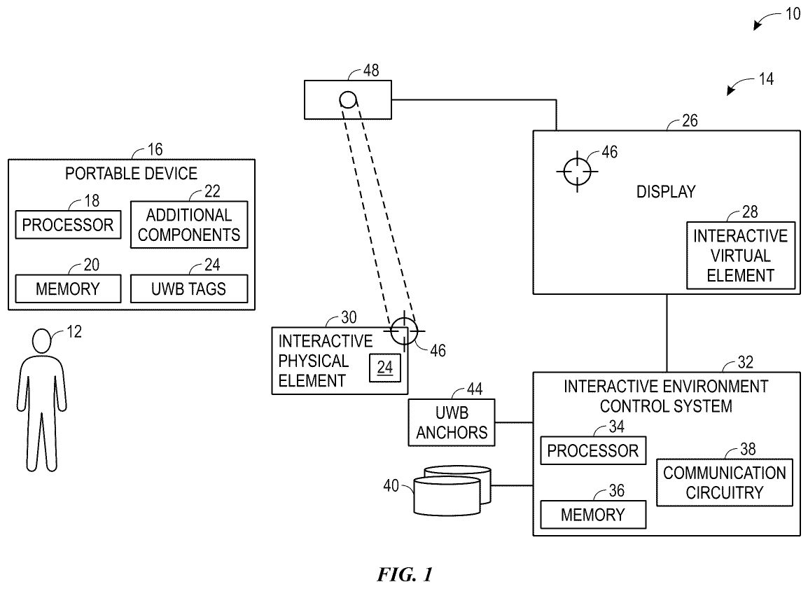

FIG. 1 illustrates an interactive system 10 that facilitates interactions within an interactive environment 14, in accordance with an embodiment of the present disclosure. The interactive environment 14 may be within an amusement park attraction or other suitable location. As shown, a guest (e.g., user) 12 may carry or otherwise be associated with a portable device 16 that may include a processor 18, a memory device 20, and additional components 22. The additional components 22 may include a circuit board, an input system (e.g., input mechanism (e.g., trigger switch, push-button)), a light emitter (e.g., light emitting diode [LED]), a haptic feedback device, a display screen, a battery, battery management system, a speaker, a microphone, an inertial measurement unit, a near-field communication (NFC) circuitry, an ultra-high frequency (UHF) circuitry, one or more additional and/or alternate sensors, one or more additional and/or alternate output systems (e.g., digital and/or virtual output systems, physical output systems, output devices) or any combination thereof. The portable device 16 may be used to target and/or interact with interactive elements (e.g., interactive virtual elements, interactive physical elements, and/or interactive hybrid elements).

Advantageously, the portable device 16 may be equipped with ultra-wideband (UWB) tags 24 that enable monitoring (e.g., continuous monitoring) of a position and/or an orientation of the portable device 16 (e.g., relative to a coordinate system; within the interactive environment 14). In addition, the UWB tags 24 are part of a UWB circuitry (e.g., a UWB system) that generates and efficiently communicates position data and/or orientation data, which may enable an interactive environment control system 32 to accurately determine successful virtual interaction (e.g., successful targeting) of the interactive elements with the portable device 16. It should be appreciated that any other suitable components may be utilized to detect the position and/or the orientation of the portable device 16 (e.g., one or more sensors, such as accelerometers, on the portable device 16, and communication circuitry to send data from the sensors to the interactive environment control system 32; one or more sensors, such as imaging sensors/cameras, off-board the portable device 16 and in the interactive environment 14). Also, such components may be excluded to avoid associated maintenance and expense. In an embodiment, no light emitters, lasers, or line-of-sight sensing devices are utilized to detect the position and/or the orientation of the portable devices 16.

The interactive environment 14 may include one or more display screens 26 that are configured to display interactive virtual elements 28. The interactive virtual elements 28 may include images (e.g., moving images; videos) of animated objects, such as symbols, coins/prizes, vehicles, and/or characters. The interactive virtual elements 28 may move in two dimensions (2D) in the virtual space on the display screen 26. In addition, the interactive environment 14 may include one or more interactive physical elements 30 that are placed or built into the interactive environment 14. The interactive physical elements 30 may include physical structures, props, vehicles, and/or robots. The interactive physical elements 30 may move in three dimensions (3D) in the physical, real-world space within the interactive environment 14.

As the guest 12 travels through the interactive environment 14, the guest 12 may be presented with the interactive elements. For example, images of animated objects may move across the display screen 26 and/or robots may move in the interactive environment 14. The guest 12 may use the portable device 16 to virtually interact with (e.g., target) the interactive elements, such as by actuating the input mechanism on the portable device 16 to launch virtual projectiles toward the interactive elements. Virtual projectiles may not have a physical embodiment or actual representation (e.g., virtual projectiles may not be seen or sensed; may not be present in the physical, real-world space and/or in the virtual space). However, in an embodiment, images of the virtual projectiles may be shown on the display screen 26. In addition, the interactive elements may respond to virtual interactions with virtual projectiles by producing a response (e.g., moving, stopping, disappearing, ducking, becoming agitated) to provide feedback about the trajectory of the virtual projectile to the guest 12.

In an embodiment, the interactive system 10 may award points (e.g., achievements) to the guest 12 for each successful “strike” at the interactive elements and the points may be added to a guest profile of the guest 12. In an embodiment, the interactive environment control system 32 (also referred to herein as “a control system 32”) may track the successful targeting of interactive elements and update the guest profile for the guest 12 as the guest 12 travels through the interactive environment 14 (e.g., in real-time). The guest profiles and the associated award points may be stored in one or more databases 40 accessible by the interactive environment control system 32. In an embodiment, a processor 34 (e.g., the processor 34 of the control system 32) may transfer the award points and/or a final guest profile to the one or more databases 40 at a conclusion of the interactive experience for use in future interactive experiences. In this way, the guest profile of the guest 12 may be maintained and updated across multiple visits to the interactive environment 14.

The interactive environment control system 32 may be responsible for controlling interactive physical elements 30 and interactive virtual elements 28 to produce responses to virtual interactions (also referred to herein as “interactions”) between virtual projectiles released by the portable devices 16 and the interactive elements in the interactive environment 14. For example, the control system 32 may move or otherwise change the interactive elements in response to the position data and/or the orientation data indicating that the portable device 16 is aimed at the interactive element prior to and/or during actuation of the input mechanism (e.g., the interactive element ducking and/or moving to evade targeting).

In addition, the control system 32 may be responsible for tracking the interactions between the physical objects (e.g., portable devices 16 and interactive physical elements 30) and the virtual objects (e.g., interactive virtual elements 28) in the interactive environment 14. As mentioned, this may involve calculating the trajectories of the virtual projectiles with an aim of determining whether the virtual projectile may reach or has reached a target (e.g., based on the position data and/or the orientation data during the actuation of the input mechanism, as well as respective locations of the interactive elements).

The control system 32 may include the processor 34, a memory device 36, and communication circuitry 38 to enable the control system 32 to control features within the interactive environment 14 (e.g., control the interactive elements and/or produce special effects in the interactive environment 14) and/or communicate with the portable device 16. The processor 34, the memory device 36, and the communication circuitry 38 may enable the control system 32 to control the movements of interactive physical elements 30 and the interactive virtual elements 28, track locations of the interactive physical elements 30 and the portable devices 16, access locations of the interactive virtual elements 28, and calculate/simulate trajectories of the virtual projectiles.

The memory device 36 may include one or more tangible, non-transitory, computer-readable media that store instructions executable by the processor 34 and/or store data (e.g., guest profile) to be processed by the processors 34. For example, the memory device 36 may include random access memory (RAM), read only memory (ROM), rewritable non-volatile memory such as flash memory, hard drives, optical discs, and/or the like. Additionally, the processor 34 may include one or more general purpose microprocessors, one or more application specific processors (ASICs), one or more field programmable gate arrays (FPGAs), or any combination thereof. Further, the memory device 36 may store instructions executable by the processor 34 to perform the methods and control actions described herein for the interactive system 10.

Tracking the virtual interactions (between the portable devices 16 and the interactive elements may involve mapping physical objects (e.g. the portable devices 16 and the interactive physical elements 30) that exist in the physical, real-world space onto the virtual space/interactive space. In an embodiment, the virtual space and the interactive space may be the same space. In this case, the interactive virtual elements 28, which exist in the virtual space, may not need to be mapped. In an embodiment, the virtual space may be distinct from the interactive space. In this case, the interactive virtual elements 28 may be mapped from the virtual space to the interactive space.

Generally, the physical, real-world space refers to a ‘space’ where only interactions between the physical objects (e.g., the portable devices 16, the interactive physical elements 30) and guests 12 take place. That is, the physical, real-world space is where the guests 12 are physically present. The virtual space refers to a ‘space’ seen by the guests 12 on the display screen 26. The images on the display screen 26 may not appear two-dimensional (2D). Instead, images on the display screen 26 may appear as a three-dimensional (3D) extension of the interactive environment 14 (e.g., extension of and/or connected to the physical, real-world space). The interactive space is the ‘space’ where the dynamic interactions between the physical objects (e.g., the portable devices 16, the interactive physical elements 30) and the virtual objects (e.g., the virtual projectiles, the interactive virtual elements 28) takes place. For example, a virtual projectile may “hit” an interactive physical element 30 in the interactive space. In this way, the interactive space makes it possible for the guests 12 to interact and observe interactions across the physical, real-world space and the virtual space.

Generally, there are various ways of mapping physical/virtual objects to the interactive space. In an embodiment, mapping of the portable devices 16 and the interactive physical elements 30 from the physical, real-world space to the interactive space may involve tracking, via the UWB tags 24, the locations of the portable devices 16 and the interactive physical elements 30 in the physical space and translating the locations onto the interactive space. In an embodiment, mapping of the interactive physical elements 30 and the interactive virtual elements 28 from physical/virtual space onto the interactive space may involve accessing, via the processor 34 of the control system 32, pre-programmed locations/movements of the interactive physical elements 30 and the interactive virtual elements 28, and translating the pre-programmed locations/movements to the interactive space. In this embodiment, exact locations of interactive elements may be known without use of the UWB tags 24. In an embodiment, mapping of the portable devices 16 and interactive elements onto the interactive space may involve a combination of above embodiments (e.g., tracking the locations of the portable devices 16 and the interactive physical elements 30 using the UWB tags 24 and assessing pre-programmed locations/movements of the interactive physical elements 30 and the interactive virtual elements 28).

In an embodiment, the UWB tags 24 may be used to track the locations of the portable devices 16 and the interactive physical elements 30. In particular, the UWB tags 24 and UWB anchors 44, which are in communication with the control system 32, may be part of a real-time locating system that performs continuous location tracking (e.g., position and/or orientation tracking) within the interactive environment 14. For example, the UWB tags 24 on the portable devices 16 and the interactive physical elements 30 may communicate with the UWB anchors 44, which may be distributed throughout the interactive environment 14, to send positioning data. The UWB anchors 44 may then send the positioning data to the control system 32.

The data from the UWB tags 24 and the UWB anchors 44 may enable the processor 34 to perform trajectory mapping for the virtual projectiles (e.g., determine a trajectory, such as a virtual flight path) in the interactive environment 14. The trajectory of the virtual projectiles may be used to represent a “hit” location and/or an angle of impact of the virtual projectiles in the interactive environment 14 (e.g., on the display screen 26) to provide a realistic experience to the guest 12. For example, when the guest 12 “fires” the virtual projectile toward an interactive physical element 30, it is not clear to the guest 12 that the virtual projectile reaches the interactive physical element 30 because the virtual projectile is invisible in the physical, real-world space. However, the trajectory of the virtual projectile can be calculated/simulated in the interactive space, and the mapped location of the interactive physical element 30 may be used to determine the possibility of impact. Thus, successful virtual interaction (e.g., targeting, aiming at, “hitting”, “striking”) of the interactive physical element 30 with the virtual projectile may be determined in the interactive space. The successful virtual interaction with the interactive physical element 30 may produce a response, which may be influenced by the trajectory of the virtual projectile. For example, after being “hit” by the virtual projectile, the interactive physical element 30 may collapse in the direction from which it was “hit.”

As previously noted, it may also be beneficial to provide users with feedback indicative of where the portable device 16 is aiming, such as via a graphical indicator (e.g., a reticle). Traditionally, feedback regarding aim may be provided via a light emitted from the portable device 16 (e.g., via a laser pointer of the portable device 16). However, this can cause added maintenance and expenses. Accordingly, present embodiments employ the data from the UWB tags 24 and the UWB anchors 44 to enable the processor 34 to determine where the portable device 16 (e.g., a blaster) is pointing (an aim location) in the interactive environment 14. Using the determined aim location, a graphical indicator of the aim location can be provided as feedback to the user. For example, the display screen 26 (e.g., a backlit display, such as an LED television) may present an aim point graphic 46 (e.g., a reticle graphic) at a location on the display screen 26 corresponding to the aim location. Thus, any time the portable device 16 is determined to be aimed at an aim location on any of a plurality of display screens (e.g., the display screen 26), the aim point can be indicated by a corresponding aim point graphic 46 and can give the user feedback without requiring any kind of light emitter (e.g., a laser pointer) on the portable device for this purpose. Further, when the portable device 16 is aimed at something other than a display screen (e.g., a wall, prop, or interactive physical element), the aim location may still be determined and may be employed by a projector 48 (which may be controlled based on instructions from the interactive environment control system 32) to project the aim point graphic 46 onto any surface, including a surface of the display screen 26. For example, in the illustrated embodiment, the projector 48 is shown presenting a version of the aim point graphic 46 on a portion of the interactive physical element 30 (with another portion being presented on a background surface). It should be noted that the projector 48 represents any number of projectors that may work together to provide a single reticle, multiple reticles, and/or to provide a range of projection (e.g., to reach different surfaces in an environment). Further, the aim point graphic 46 may be adjusted by the interactive environment control system 32, the projector 48, and/or the display screen 26 to change color or change other graphic aspects based on an operational mode of the portable device 16 (e.g., a type of virtual projectile (e.g., type of virtual ammunition (ammo)) the portable device is launching). By detecting position and orientation using the UWB tags 24 and the UWB anchors 44, present embodiments can provide aiming feedback, such as via a reticle, without requiring the portable device 16 to house a feature for emitting light to provide such feedback.

In an embodiment, the additional components 22 of the portable device 16 may provide various types of feedback (e.g., special effects) to the guest 12 based on the interaction between the portable device 16 and interactive elements in the interactive environment 14. For example, the additional components 22 (e.g., light emitter, haptic device, display screen, speaker) may provide respective feedback upon the successful targeting of the interactive element and/or upon points being assigned to the guest profile. For example, the feedback provided by the additional components 22 may involve vibration/recoil when the virtual projectile is “fired.” In another example, the feedback provided by the additional components 22 in response to the virtual projectile “hitting” an interactive virtual element 28 may include a sound of a bang emitted by the speaker(s). In an embodiment, additional device(s) (e.g., light emitter, haptic device, speaker, or a combination thereof) that provide feedback/special effects may be distributed throughout the physical, real-world space within the interactive environment 14.

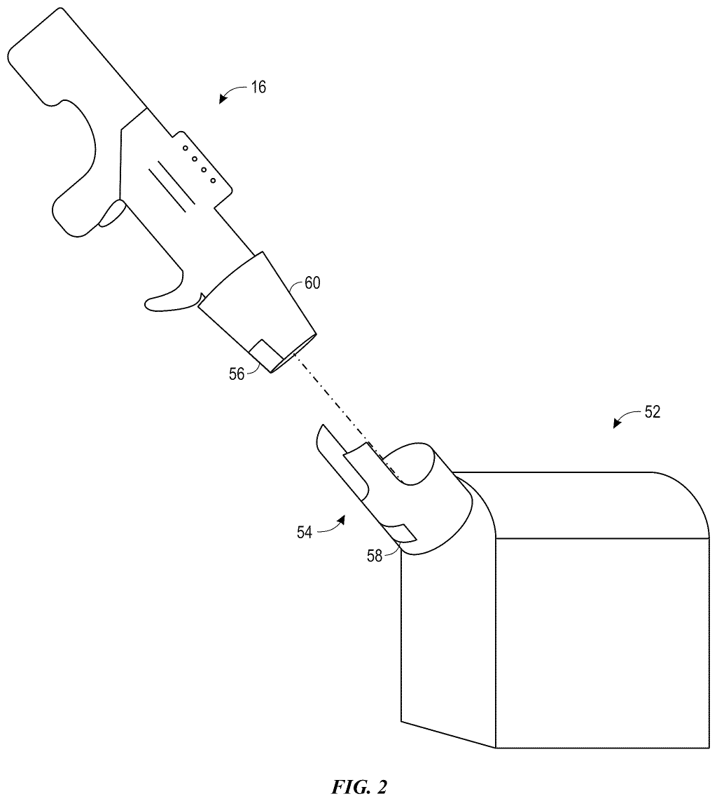

FIG. 2 depicts a perspective view of the portable device 16 being inserted into a charging station 52, in accordance with an embodiment of the present disclosure. As previously discussed, present embodiments may conserve energy by avoiding the need for certain onboard devices (e.g., laser pointers). However, present embodiments may still employ onboard devices that require energy and a battery system. Accordingly, present embodiments provide recharging capabilities via features of the portable device 16 and the charging station 52, which will be described in further detail below. It should be noted that aspects of the charging station 52 and aspects of the portable device 16, such as a battery of the portable device 16, may cumulatively be referred to as a charging system.

With respect to FIG. 2, an embodiment in shown in which the portable device 16 can be slid into a cradle 54 of the charging system 52 to establish a charging configuration of the portable device 16 and the charging system 52. When the portable device 16 is slid into the cradle 54, an electrical coupling between a portable device electrical coupler 56 (e.g., charging pins) and a charging system electrical coupler 58 (e.g., charging pads) may be established. In the illustrated embodiment, the portable device electrical coupler 56 is located on a nose cone 60 of the portable device and the charging system electrical coupler 58 is located within the cradle 54. However, in other embodiments, different arrangements may be employed, such as in a manner that facilitates electrical engagement between the portable device 16 and the charging system 52 without requiring use of fasteners or tools. In other embodiments, the portable device electrical coupler 56 may include a plug (e.g., prongs) that are interested into receptacles of the charging system electrical coupler 58 or other types of electrical engagement and physical support.

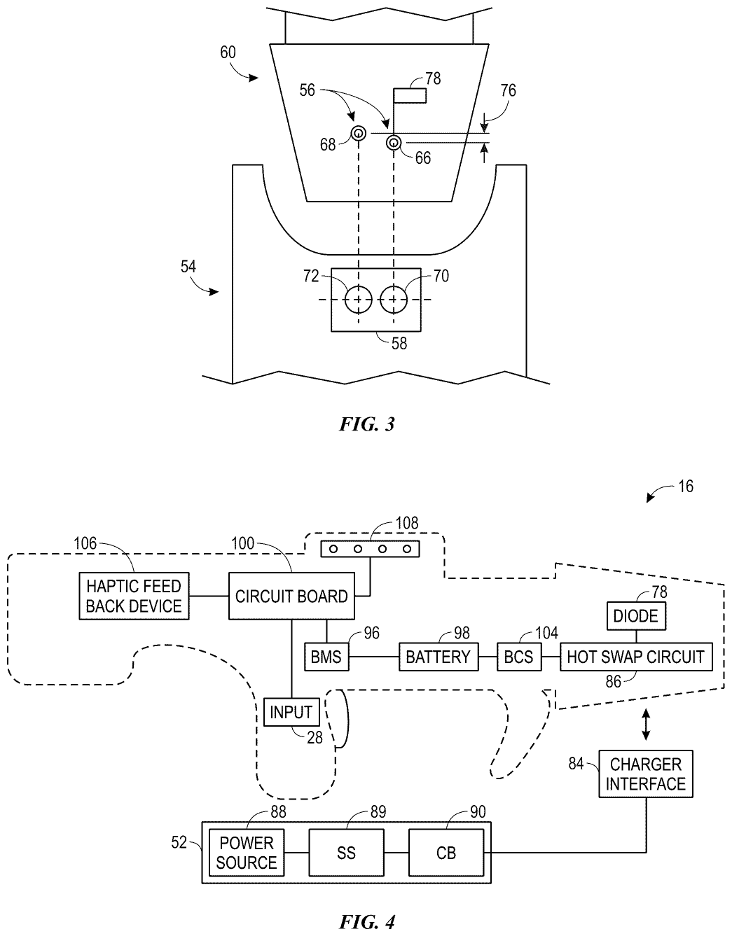

FIG. 3 is a schematic bottom view of the nose cone 60 of the portable device 16 and the cradle 54, wherein the portable device electrical coupler 56 is being coupled to the charging system electrical coupler 58, in accordance with an embodiment of the present disclosure. In the illustrated embodiment, the portable device electrical coupler 56 includes a ground pin 66 and a positive power pin 68. Correspondingly, the charging system electrical coupler 58 includes a ground pad 70 and a positive pad 72, which provide a ground connection and a positive electrical source, respectively. As previously noted, the portable device 16 slides into engagement with the charging station 52, and thus, the portable device electrical coupler 56 slides into engagement with the charging system electrical coupler 58 in a direction (as shown by arrow 74). In the illustrated embodiment, the ground pin 66 and the positive power pin 68 are offset along the direction 74 by a distance 76, while the ground pad 70 and the positive pad 72 are aligned. This positioning facilitates electrical coupling of the ground pin 66 and the ground pad 70 prior to applying positive electrical current via the positive pad 72 and the positive power pin 68. By establishing the ground connection prior to applying power, present embodiments can avoid unintentional grounding and other potential electrically damaging issues. Further, one or more diodes 78 may be positioned to prevent reverse polarity such that, even if an error in assembly results in reversed wiring in the charging system, the one or more diodes 78 will prevent electrical transmission and related damage. For example, even if positive power is applied to the ground pin 66 by mistake, the diode(s) 78 will prevent it from passing through.

FIG. 4 is a schematic diagram of the charging system and various protective layers within the charging system, in accordance with an embodiment of the present disclosure. To protect the portable device 16 from abnormal voltage and/or current transmissions (e.g., transient voltage and/or current), present embodiments may incorporate various layers of electrical protection. For example, these layers may prevent damage to the portable device 16 or at least prevent damage to certain critical and/or expensive components thereof by protecting against oscillatory/aperiodic current and/or unwanted voltage swings (e.g., due to electromagnetic disturbances).

In the illustrated embodiment, the charging station 52 may interface with and charge the portable device 16 through connection via electrically conducting (e.g., metal) components, such as the portable device electrical coupler 56 (e.g., the ground pint 66 and the positive power pin 68) and the charging system electrical coupler 56 (e.g., the ground pad 70 and the positive pad 72). A charger interface 84 may include the charging system electrical coupler 56 and a hot swap circuit 86 may include (or at least directly couple with) the portable device electrical coupler 56.

Power for charging the portable device 16 may originate from a power source 88 (e.g., a generator, a large battery, an outlet or other connection to a power grid) and pass through a surge stopper 89 (a first layer of protection) and a circuit breaker 90 (a second layer of protection) of the charging system that prevent an over-current or over-voltage event from entering the portable device 16. The surge stopper 89 and the circuit breaker 90 may operate to rapidly eliminate transient voltage or current, even voltage or current that is transient for only 20 milliseconds.

The hot swap circuit 86 may operate as a third layer of electrical protection. The hot swap circuit 86 is incorporated into the portable device 16 (e.g., on the nose cone 60) to facilitate engagement with the charging station 52 and transfer of electricity from the charging station 52 to the portable device 16. The hot swap circuit 86 may employ one or more linear diodes to prevent transient voltage/current from entering the portable device 16. As noted above, the hot swap circuit 86 may include onboard conductive portions (e.g., the ground pin 66 and the positive power pin 68) that contact features of the charger interface 84 in an engaged configuration. For example, the hot swap circuit 86 may engage and conduct electricity when the portable device 16 is holstered in a charging receptacle of the charging interface 84. The hot swap circuit 85 may be designed such that current or voltage above a threshold entering the hot swap circuit 86 will cause it to sacrifice itself, blow the diode 78, or perform some other failure mechanism to prevent damage to downstream components of the portable device 16, such as a battery management system 96, a battery system 98 (e.g., one or more batteries), a circuit board 100, or the like.

As discussed with respect to FIG. 3, a fourth layer of protection may include the positioning (e.g., relative positioning) of aspects of the portable device electrical coupler 56 and/or the charging system electrical coupler 56. Specifically, as noted above with respect to the embodiment illustrated in FIG. 3, the ground pin 66 and the positive power pin 68 may be offset along the direction 74 by a distance 76, while the ground pad 70 and the positive pad 72 are aligned such that ground contact is initiated upon sliding engagement of the portable device 16 and the cradle 54 along the direction 74 before engagement of the power pin 68 and the positive pad 72. Other offset arrangements of different conductive components are also contemplated that would achieve a similar result and add a layer of protection from unintended electrical conduction scenarios.

A fifth layer of protection may include a battery charging circuit (BCS) 104 that communicates with the battery management system (BMS) 96. The BMS 96 may perform an oversight function for the battery system 96 (e.g., an assembly of battery cells) and powered features. The BMS 96 may enable delivery of targeted amounts of voltage and/or current to address certain power scenarios. The BCS 104 may serve as an override control feature. In normal operation, the BCS 104 may direct electricity to the battery system 96 (e.g., a single or multiple batteries) for charging of the battery system 96. The BMS 96 and/or the BCS 104 may communicate information regarding a status or state of the battery system 96. Thus, the BCS 104 and the BMS 96 may cooperate to communicate regarding power needs and control transfer of power through the portable device 16. For example, the BMS 96 and the BCS 104 may cooperate to power a haptic feedback device 106, a visual output 108 (e.g., LEDs), or an input 110 (e.g., a trigger mechanism). Such control may include operating to avoid damage to certain components by preventing overcharging and the like. For example, the BCS 104 may be instructed by the BMS 96 to limit or block electrical flow to facilitate a power management function. Also, the BCS 104 may operate to block flow (e.g., in an overcharge scenario) to protect the BMS 96.

While only certain features have been illustrated and described herein, many modifications and changes will occur to those skilled in the art. It is, therefore, to be understood that the appended claims are intended to cover all such modifications and changes as fall within the true spirit of the disclosure.

The techniques presented and claimed herein are referenced and applied to material objects and concrete examples of a practical nature that demonstrably improve the present technical field and, as such, are not abstract, intangible or purely theoretical. Further, if any claims appended to the end of this specification contain one or more elements designated as “means for (perform)ing (a function) . . . ” or “step for (perform)ing (a function) . . . ”, it is intended that such elements are to be interpreted under 35 U.S.C. 112(f). However, for any claims containing elements designated in any other manner, it is intended that such elements are not to be interpreted under 35 U.S.C. 112(f).

1. A portable device aim identification system, comprising:
a display screen;
a portable device comprising multiple antennas;
a transceiver separate from the portable device, wherein the transceiver and the multiple antennas are configured to generate data based on signals communicated between the transceiver and the multiple antennas; and
an interactive device system configured to:
track position and/or orientation of the portable device based on the data;
identify an aim location of the portable device based on the position and/or orientation of the portable device; and
control the display screen to present a graphic at the aim location in response to the aim location being on the display screen.

2. The portable device aim identification system of claim 1, comprising a projector configured to present a projection graphic at the aim location in response to the aim location being on a surface other than the display screen.

3. The portable device aim identification system of claim 1, wherein the multiple antennas are disposed in different locations on one or more surfaces of the portable device.

4. The portable device aim identification system of claim 1, wherein the interactive device system is configured to track the position and/or orientation of the portable device based on the data by determining time of flight information.

5. The portable device aim identification system of claim 1, comprising a charging station configured to electrically couple to the portable device.

6. The portable device aim identification system of claim 5, wherein the charging station comprises a surge stopper, a circuit breaker, or both.

7. The portable device aim identification system of claim 1, wherein the portable device comprises a hot swap circuit configured to prevent the portable device from receiving a voltage or a current that exceeds a threshold.

8. The portable device aim identification system of claim 7, wherein the hot swap circuit is configured to engage with a charging station configured to electrically couple to the portable device.

9. The portable device aim identification system of claim 1, wherein the portable device comprises:
one or more feedback devices configured to emit feedback based on the aim location of the portable device;
a battery system configured to provide power to the one or more feedback devices; and
a battery charging circuit configured to limit electrical flow to the battery system.

10. The portable device aim identification system of claim 1, wherein portable device comprises a plurality of conductive portions disposed on a body of the portable device, and the plurality of conductive portions is configured to electrically couple to a charging station.

11. A system, comprising:
a portable device, comprising:
multiple antennas configured to communicate with a transceiver to provide data indicating an aim location of the portable device;
one or more feedback devices configured to emit feedback based on the aim location of the portable device;
a battery system configured to provide power to the one or more feedback devices; and
a charging station configured to electrically couple to the battery system of the portable device to provide charging to the battery system.

12. The system of claim 11, wherein the portable device comprises a plurality of conductive portions disposed on a body of the portable device, and the plurality of conductive portions is configured to electrically couple to the charging station.

13. The system of claim 11, wherein the battery system comprises a battery and a battery charging circuit, and the battery charging circuit is configured to limit electrical flow to the battery.

14. The system of claim 11, wherein the one or more feedback devices are configured to emit the feedback in response to the aim location of the portable device corresponding to at least one of an interactive physical element target or an interactive virtual element target.

15. The system of claim 14, comprising:
processing circuitry comprising one or more processors; and
memory storing instructions that, when executed by the processing circuitry, causes the processing circuitry to:
determine the aim location of the portable device based on the data;
determine that the aim location of the portable devices corresponds to at least one of the interactive physical element target or the interactive virtual element target; and
instruct the one or more feedback devices to emit the feedback in response to determining that the aim location of the portable device corresponds to the at least one of the interactive physical element target or the interactive virtual element target.

16. The system of claim 11, wherein the portable device comprises a hot swap circuit configured to prevent the portable device from receiving a voltage or a current from the charging station that exceeds a threshold.

17. A system, comprising
a charging station comprising a first electrical coupler comprising a first conductor and a second conductor; and
a portable device, comprising:
a second electrical coupler comprising a third conductor and a fourth conductor offset from one another relative to a direction of movement of the portable device to couple to the charging station;
a battery system configured to charge a battery to store power via contact between the first electrical coupler and the second electrical coupler; and
one or more feedback devices configured to use the power to emit feedback.

18. The system of claim 17, wherein the first conductor comprises a ground pad, the second conductor comprises a positive power pad, the third conductor comprises a ground pin, and the fourth conductor comprises a positive power pin.

19. The system of claim 17, wherein the first conductor and the second conductor are aligned relative to the direction of movement of the portable device to couple to the charging station.

20. The system of claim 17, wherein the portable device comprises a hot swap circuit configured to prevent the portable device from receiving a voltage or a current from the charging station that exceeds a threshold.
